(19) United States
(12) Patent Application Publication
(10) Pub. No.: US 2025/0053386 A1
(43) Pub. Date: Feb. 13, 2025

(54) MAPPING DESIGN ARTIFACTS TO A REFERENCE FRAMEWORK

(71) Applicant: Wells Fargo Bank, N.A., San Francisco, CA (US)

(72) Inventors: Ashequr Rahman, Brooklyn, NY (US); Vikram Odury, Dallas, TX (US); Yasser A. Khashaba; Shreeraj Pillai, Charlotte, NC (US)

(21) Appl. No.: 17/664,341

(22) Filed: May 20, 2022

(51) Int. Cl. G06F 8/34; G06F 8/35; G06F 8/36; G06F 8/60

(52) U.S. Cl. CPC G06F 8/34; G06F 8/35; G06F 8/36; G06F 8/60

(57) ABSTRACT

This disclosure describes techniques that include the design, development, and/or use of a structure, metadata specification, or language that facilitates the transition of design artifacts directly into a structured programming code template. In one example, this disclosure describes a method comprising enabling a domain-driven design process for an application, wherein the domain-driven design process produces a plurality of design artifacts associated with a domain-driven design of the application; outputting, by a computing system, a user interface configured to receive information about a mapping of the plurality of design artifacts to a framework of library code; identifying, by the computing system and for the design artifacts, a code template from the framework of library code; generating, by the computing system and based on the identified code templates, a skeleton application; enabling, by the computing system, modification of the skeleton application to produce a production application.

### TECHNICAL FIELD

This disclosure relates to design of application programs, and more specifically, to tools that enable more efficient computer programming processes.

### BACKGROUND

Domain-Driven Design (DDD) is a software design and development process that models software to match a domain, often a “business domain.” Typically, for software developed using DDD, the structure and language of the software code (object or class names, object methods, object variables) match the domain. The DDD process sometimes involves an “event storming” effort during which stakeholders associated with a project (programmers, businesspeople, and “domain experts”) gather to discuss and settle on a technology-neutral understanding of the business domain and the problem to be addressed. Domain experts are people who have expertise in the relevant domain or business processes that the software will address. For example, for a software program that processes loan applications, a domain expert might be a loan officer or banker. In many cases, the businesspeople and the domain experts could be the same people.

Once a common understanding of the business domain and the problem to be addressed by a new software application is established, the DDD process involves generating a model of the new software using the agreed-upon language and concepts. This process results in a set of business concepts or modeling artifacts (i.e., “design artifacts”) corresponding to the relevant domain or business domain.

### SUMMARY

This disclosure describes techniques that include the design, development, and/or use of a structure, metadata specification, or language that facilitates the transition of design artifacts directly into a structured programming code template. In some examples, the structure, metadata specification, or language may take the form of a reference framework that is designed to support the intake of design artifacts or DDD artifacts resulting from an application design process. Such a framework may enable design artifacts to be decoupled from the design process and mapped to infrastructure and boilerplate coding, thereby enabling a separation of code from business logic in a configurable and abstracted manner. As described herein, design artifacts are aligned with the reference framework, which then enables aspects of the design to be mapped directly to programming code templates configured to implement some or all of the desired functionality associated with each such design artifact. The mapped code templates are then assembled into a skeletal program design that the developer can use as a starting point for application development. The developer then implements business logic or other specialized aspects of the application under design. Techniques described herein may facilitate development of application programs, including those based on modern architecture cloud-based systems, by reducing developer time and improving time to market.

In some examples, this disclosure describes operations performed by an application design system in accordance with one or more aspects of this disclosure. In one specific example, this disclosure describes a method comprising enabling a domain-driven design process for an application, wherein the domain-driven design process produces a plurality of design artifacts associated with a domain-driven design of the application; outputting, by a computing system, a user interface configured to receive information about a mapping of the plurality of design artifacts to a framework of library code; identifying, by the computing system and for the design artifacts, a code template from the framework of library code; generating, by the computing system and based on the identified code templates, a skeleton application; enabling, by the computing system, modification of the skeleton application to produce a production application; and deploying, by the computing system, the production application.

In another example, this disclosure describes a system comprising processing circuitry and a storage device, wherein the processing circuitry has access to the storage device and is configured to: enable a domain-driven design process for designing an application, wherein the domain-driven design process produces a plurality of design artifacts associated with a domain-driven design of the application; output a user interface configured to receive information about a mapping of the plurality of design artifacts to a framework of library code; identify, for the design artifacts, a code template from the framework of library code; generate, based on the identified code templates, a skeleton application; enable modification of the skeleton application to produce a production application; and deploy the production application.

In another example, this disclosure describes a computer-readable storage medium comprising instructions that, when executed, configure processing circuitry of a computing system to: enable a domain-driven design process for designing an application, wherein the domain-driven design process produces a plurality of design artifacts associated with a domain-driven design of the application; output a user interface configured to receive information about a mapping of the plurality of design artifacts to a framework of library code; identify, for the design artifacts, a code template from the framework of library code; generate, based on the identified code templates, a skeleton application; enable modification of the skeleton application to produce a production application; and deploy the production application.

The details of one or more examples of the disclosure are set forth in the accompanying drawings and the description below. Other features, objects, and advantages of the disclosure will be apparent from the description and drawings, and from the claims.

### BRIEF DESCRIPTION OF THE DRAWINGS

FIG. 1A is a conceptual diagram illustrating an example system for interpreting design artifacts and transforming design artifacts into source code, in accordance with one or more aspects of the present disclosure.

FIG. 1B is a conceptual diagram illustrating another example system for interpreting design artifacts and transforming such design artifacts into source code, in accordance with one or more aspects of the present disclosure.

FIG. 2 is a block diagram illustrating an example system for interpreting design artifacts and transforming design artifacts into source code, in accordance with one or more aspects of the present disclosure.

FIG. 3A through FIG. 3G illustrate example definition files that may be used to describe or define one or more aspects of a domain-driven design, in accordance with one or more aspects of the present disclosure.

FIG. 4 is a flow diagram illustrating operations performed by an example system in accordance with one or more aspects of the present disclosure.

### DETAILED DESCRIPTION

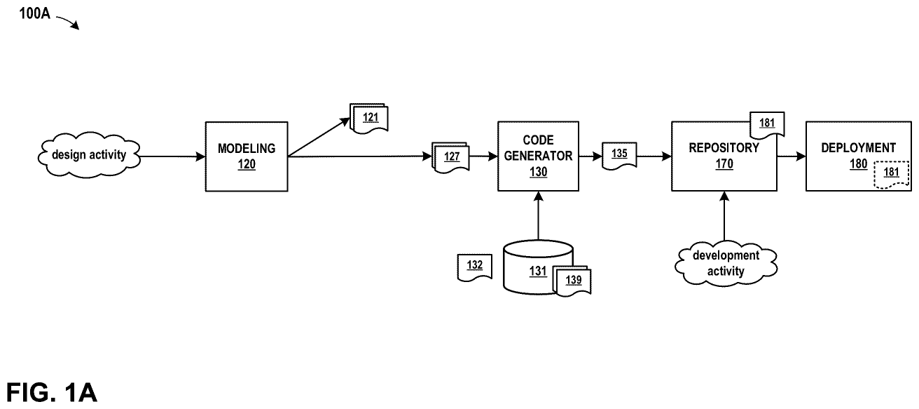

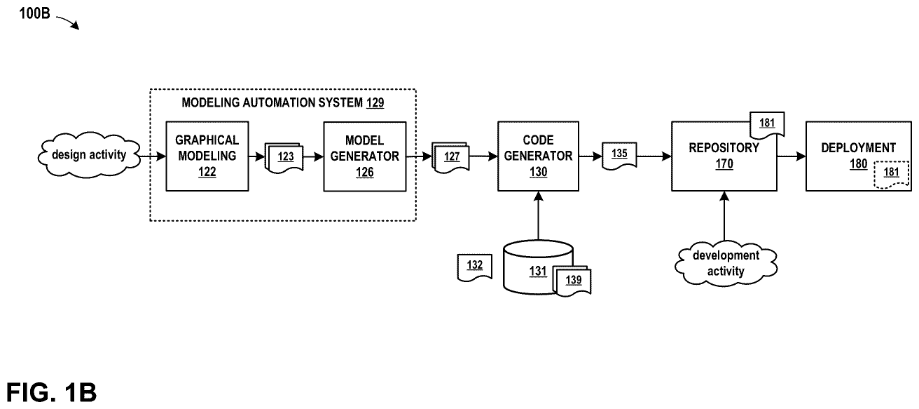

FIG. 1A is a conceptual diagram illustrating an example system for interpreting design artifacts and transforming design artifacts into source code, in accordance with one or more aspects of the present disclosure. The far left side of FIG. 1A depicts design activity that takes place as part of an application design process (e.g., a domain driven design process). That design process results in various design artifacts 121 and/or framework definition artifacts 127 that describe aspects or attributes of the application under development. To support the process of generating design artifacts 121 and framework definition artifacts 127, one or more computing systems are used. Those computing systems are represented in FIG. 1A by design modeling system 120. In general, design modeling system 120 produces design artifacts 121 and/or framework definition artifacts 127 based on input from architects, designers, and other stakeholders associated with the application under development. As described herein, design artifacts 121 and/or framework definition artifacts 127 are then transformed into configurable programming code (e.g., skeleton code 135) that a developer can then modify and/or finalize to produce an application.

To support such a process, additional systems may be employed. In the example illustrated in FIG. 1A, such systems include code generator 130, repository 170, and deployment environment 180. Such systems may generate or use various items of data, including design artifacts 121, framework definition artifacts 127, and skeleton code 135. Based on the initial design activity, and as described herein, system 100A eventually generates production code 181, which can execute within deployment environment 180.

Code library 131, also illustrated in FIG. 1A, may be a library of boilerplate code or code templates 139 that can be used to implement various functionality required to implement the application under development. Code library 131 may be a repository, data store, or computing system accessible by code generator 130. Although illustrated separately from code generator 130, code library 131 may also be implemented within code generator 130 or other systems. In some examples, code library 131 provides a framework of code templates 139. In such a framework, code templates 139 are organized into a coherent system within code library 131, such that selected code templates 139 can be drawn from code library 131 and deployed in an application in a way that enables those selected code templates 139 to operate with and interact with other selected code templates 139 deployed in the same application. Accordingly, code library 131 provides a set of code templates 139 that can be assembled to form an application or significant portions of an application under development. In some examples, some code templates 139 or aspects thereof may be taken from open source libraries or may be implemented by modifying certain open source code or other already-written code. However, code library 131 is structured to organize such code templates 139 in a way that enables a model description that is written pursuant to a language, metadata definition, or reference framework (e.g., framework specification 132, as described below) to map certain domains, objects, functionality, events, and other aspects of a model to one or more code templates 139 within code library 131.

Framework specification 132 may be a definition or description of the framework of code templates 139 within code library 131. Framework specification 132 may define how various code templates 139 may interoperate with other code templates 139, and/or how such code templates 139 may be assembled with other code templates 139 to implement functionality in an application being developed. In some examples, framework specification 132 may be (or may include) a language or metadata definition that is based on the structure, capabilities, and design of code library 131 and the code templates 139 included within code library 131. In such examples, framework specification 132 may specify how certain application functionality can be described by a developer (through use of the language) to enable that functionality to be implemented through a mapping to various code templates 139 within code library 131. Once the desired functionality is mapped to code templates 139 within code library 131, those code templates 139 can be assembled into an application or a portion of an application. In some examples, framework specification 132 establishes a structure or an organization of various operations to be performed by an application or various objects that are to be implemented by the application.

Repository 170 may a system that stores and maintains data in an organized way, and may provide controlled access to source code or other various items of data stored within the repository. Repository 170 may serve as a version control system for software development, and may provide services commonly provided by version control software, such as Git.

Deployment environment 180 may include an enterprise network, a data center, a distributed computing network, or other appropriate computing infrastructure. In some examples, deployment environment 180 may be or may include computing infrastructure for executing applications in a cloud-based microservices environment.

Each of design modeling system 120, code generator 130, code library 131, repository 170, and deployment environment 180 may be implemented through any suitable computing system including one or more server computers, workstations, mainframes, appliances, cloud computing systems, and/or other computing devices that may be capable of performing operations and/or functions described in accordance with one or more aspects of the present disclosure. In some examples, each such computing system illustrated in FIG. 1A may represent a cloud computing system, server farm, and/or server cluster (or portion thereof) that provides services to client devices and other devices or systems. In other examples, such computing systems may represent or be implemented through one or more virtualized compute instances (e.g., virtual machines, containers) of a data center, cloud computing system, server farm, and/or server cluster. Although illustrated separately in FIG. 1A, design modeling system 120, code generator 130, repository 170, or deployment environment 180 could, in some implementations, be combined into fewer systems.

In FIG. 1A, and in accordance with one or more aspects of the present disclosure, system 100A may generate design artifacts 121. For instance, in an example that can be described in the context of FIG. 1A, design modeling system 120 of system 100A receives input that it determines corresponds to application design activity performed by one or more developers and/or application design architects. In some examples, particularly for software developed pursuant to a DDD process, such efforts may involve input from domain experts or businesspeople having relevant expertise. In some cases, input received by design modeling system 120 may be derived from an event storming effort conducted by stakeholders associated with an application development project. In the DDD context, and as previously described, the design process generally involves designing an application in a way that models the application based on the domain to which it applies. That design process results in a various descriptions, requirements, features, and other information about the design of the application. Based on such information, design modeling system 120 generates design artifacts 121.

The design process may therefore result in a set of business concepts, event modeling artifacts, domains, subdomains, contexts, (i.e., design artifacts 121) corresponding to the relevant business domain. In the DDD context and in other contexts, such design artifacts 121 may include domains, subdomains, bounded contexts and relationships, events, commands, queries, policies, data objects, application programming interfaces (APIs), request and response protocols, data consistency protocols, saga pattern design considerations, and event modeling data. Design modeling system 120 may assist in generating such design artifacts 121, such as by providing text editor capabilities, graphical modeling tools, and various user interfaces and tools that can be used to model the application under development and create design artifacts 121.

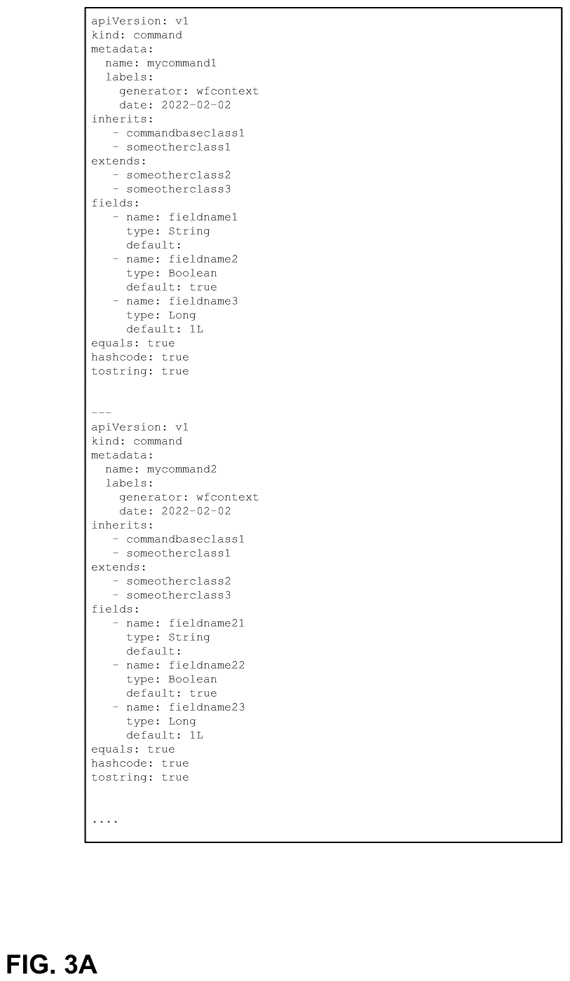

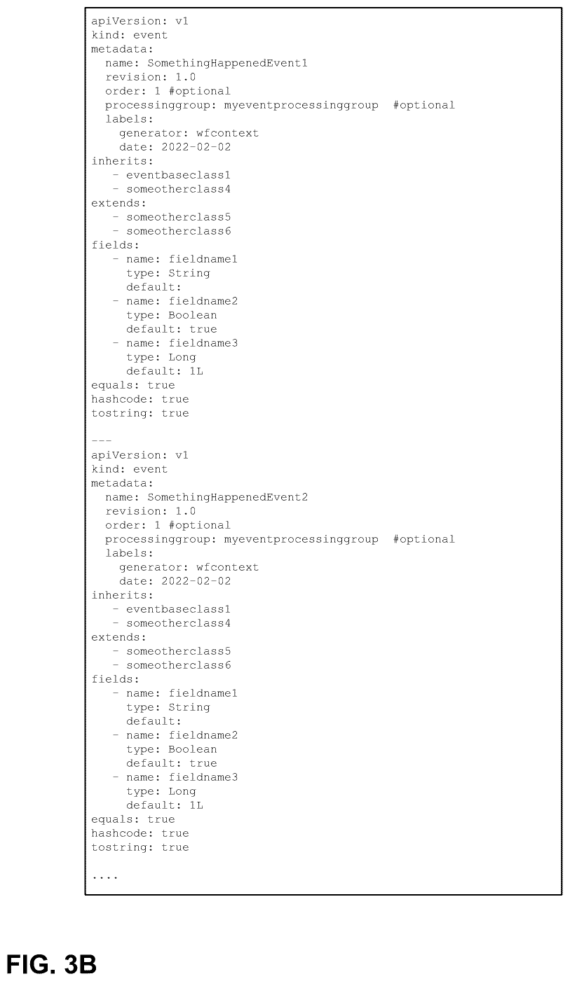

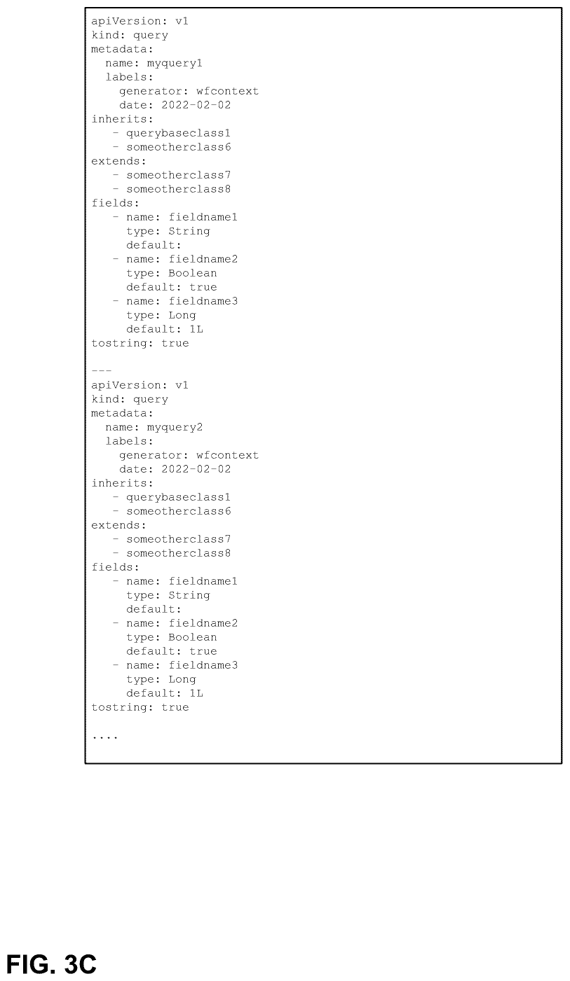

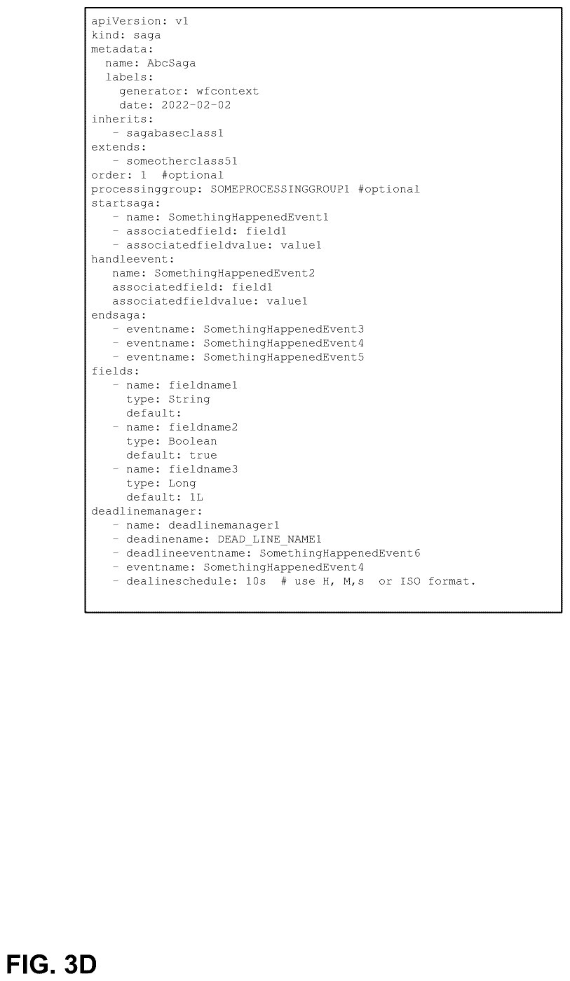

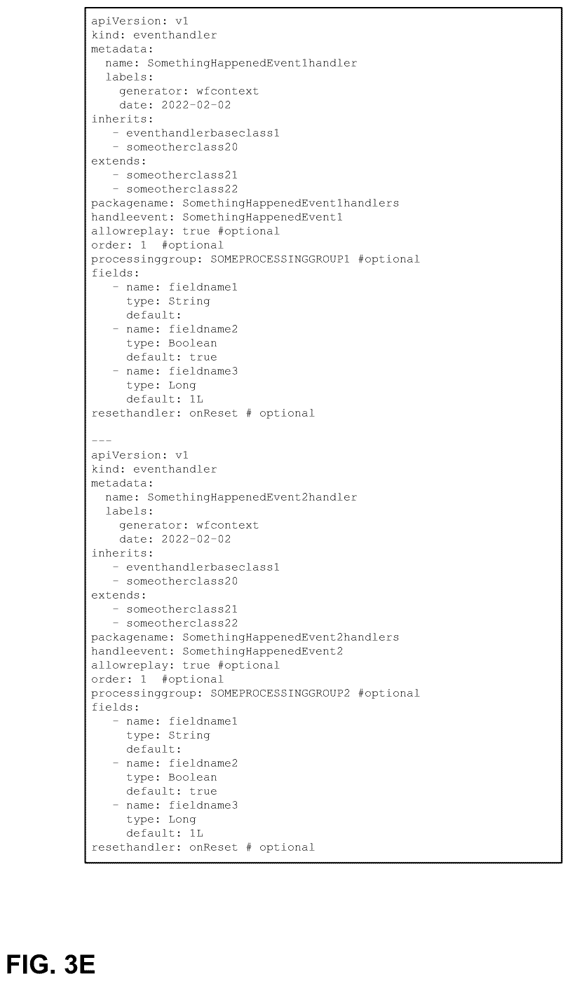

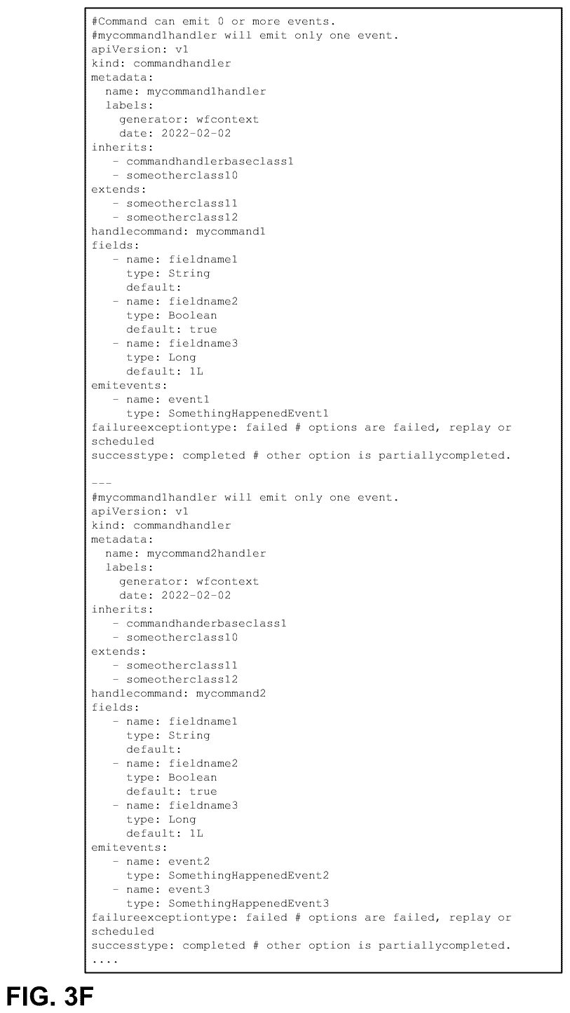

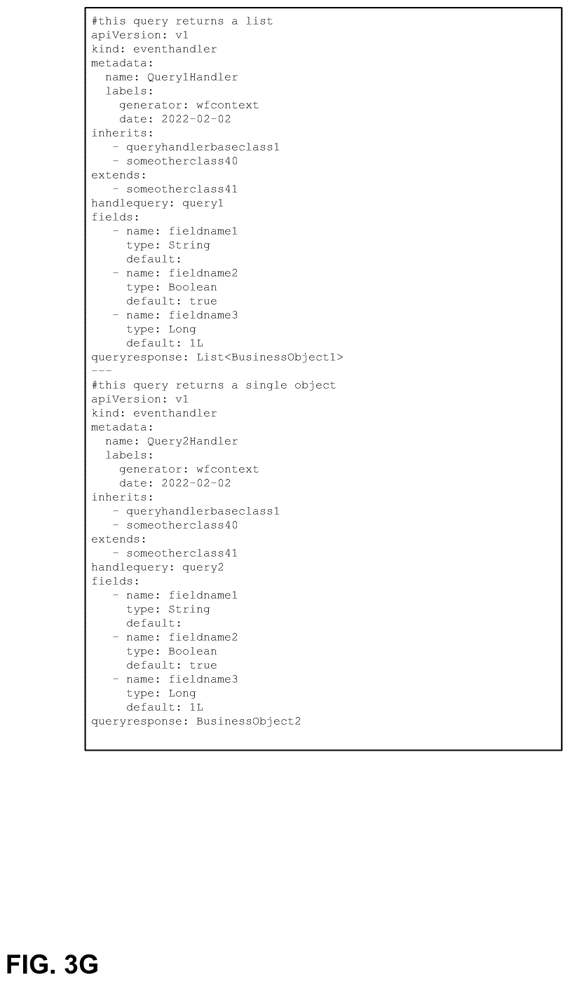

Design modeling system 120 may also generate framework definition artifacts 127, which align design artifacts 121 to framework specification 132. For instance, referring again to FIG. 1A, developers, designers, architects, and/or other stakeholders generate design artifacts 121 that correspond to a domain-driven design, but efforts are made to also (or alternatively) produce framework definition artifacts 127. Framework definition artifacts 127 are produced based on or using a language or metadata definition (i.e., framework specification 132) that defines on the structure, capabilities, and design of code library 131. In other words, when generating design artifacts 121 and/or otherwise developing a design for the desired application, architects and developers also (or alternatively) prepare framework definition artifacts 127, which describe some or all aspects of design artifacts 121 in a way that complies with framework specification 132. If framework definition artifacts 127 are prepared in a way that complies with framework specification 132, the functionality of each of framework definition artifacts 127 can be mapped to various code templates 139 within code library 131. In some examples, developers may prepare framework definition artifacts 127 by using a text editor to generate text that complies with framework specification 132. The description prepared by the developers (i.e., corresponding to framework definition artifacts 127) may take any appropriate form that expresses the design of an application in a manner that complies with framework specification 132. In some examples, framework definition artifacts 127 may be expressed by, for example, a markup or description language (e.g., XML, YAML, JSON) or in other forms. Example framework definition artifacts 127 may take the form illustrated in, for example, FIG. 3A through FIG. 3G.

Code generator 130 may generate skeleton code 135 based on framework definition artifacts 127. For instance, again referring to the example being described in the context of FIG. 1A, code generator 130 receives framework definition artifacts 127 as input. Code generator 130 identifies and/or maps various items, objects, and/or functionality descriptions within framework definition artifacts 127 to code templates 139 within code library 131. Code generator 130 selects the identified code templates 139 and combines them into skeleton code 135.

In generating skeleton code 135, code generator 130 configures various code templates 139 drawn from code library 131 to work together in a way that accomplishes the functionality and/or operational objectives of the application being designed. For example, code generator 130 may map commands described in framework definition artifacts 127 to certain command processing code templates 139 available within code library 131 and configure appropriate command handlers associated with those code templates 139 to operate in the manner specified by framework definition artifacts 127. Also, code generator 130 may map events described in framework definition artifacts 127 to appropriate Command and Query Responsibility Segregation (CQRS) code templates 139 available within code library 131 and configure an event bus to operate in a way consistent with the design as expressed by framework definition artifacts 127. Code generator 130 may also map queries described in framework definition artifacts 127 to code available within code library 131 and configure appropriate query handlers to operate in the manner specified by framework definition artifacts 127. Code generator 130 may also map various domains, subdomains, bounded contexts to appropriate code templates 139 within code library 131 and configure various objects within the design to operate as specified by framework definition artifacts 127. In general, when producing skeleton code 135, code generator 130 may map each of the items, entities, or concepts described within framework definition artifacts 127 to appropriate code templates 139 within code library 131 and make appropriate configurations for each such item, entity, or concept.

Repository 170 may produce production code 181 from skeleton code 135. For instance, still referring to FIG. 1A, code generator 130 outputs skeleton code 135 to repository 170. Repository 170 publishes skeleton code 135 and makes skeleton code 135 available for modification or further development. One or more developers access the code and engage in development activity, resulting in modifications to skeleton code 135. Those developers may commit such modifications to repository 170, moving skeleton code 135 toward a more production-ready version of the application. Typically, such modifications involve developers modifying skeleton code 135 to implement business logic or specialized processes unique to the application being designed. Often, skeleton code 135 may be sufficiently complete such that to finalize the application, developers might only need to modify skeleton code 135 to implement that business logic or those specialized processes. Eventually, sufficient development activity takes place such that modifications committed to repository 170 are sufficient to evolve skeleton code 135 into production code 181.

Repository 170 may deploy production code 181 to deployment environment 180. For instance, once again referring to the example being described in the context of FIG. 1A, repository 170 receives further input (e.g., from a developer) that it determines corresponds to a request to deploy production code 181 in a production environment. Repository 170 or another system generates an executable version of production code 181. Repository 170 outputs the executable version of production code 181 to deployment environment 180. Deployment environment 180 receives the executable version of production code 181, and configures one or more systems within deployment environment 180 to execute production code 181.

FIG. 1B is a conceptual diagram illustrating another example system for interpreting design artifacts and transforming such design artifacts into source code, in accordance with one or more aspects of the present disclosure. FIG. 1B is similar to FIG. 1A, with system 100B including many of the same elements of system 100A in FIG. 1A. Like-numbered elements illustrated in FIG. 1B thus correspond to elements illustrated in FIG. 1A and described in connection with FIG. 1A.

In FIG. 1B, however, modeling automation system 129 is illustrated as a replacement of (or as a supplement to) design modeling system 120 of FIG. 1A. As illustrated in FIG. 1, modeling automation system 129 includes graphical modeling system 122 and model generator 126. Modeling automation system 129 may serve as a graphical modeling tool that enables a developer or architect to define, draw, or visually specify various graphical model artifacts 123. Modeling automation system 129 may thus enable presentation and modification of a graphical representation of the business problem that the application under development is intended to solve. In FIG. 1, modeling automation system 129 may guide the developer or architect to define those graphical model artifacts 123 in a “low-code” or “no-code” way that automatically aligns with framework specification 132. Stakeholders (architects, developers, domain experts) can use modeling automation system 129 to create a graphical representation of the domain-driven design through a user interface, and establish connections, dependencies, variables, objects, and other artifacts through visual interaction with the user interface. Modeling automation system 129 thus may provide some degree of automation, reducing and/or eliminating the need for an architect or developer to manually prepare framework definition artifacts 127 through a text editor other possibly less convenient means.

Perhaps more significantly, however, modeling automation system 129 may also reduce or eliminate the need for the architect or developer to ensure that framework definition artifacts 127 are prepared in compliance with framework specification 132. In other words, modeling automation system 129 may be designed such that any framework definition artifacts 127 generated using modeling automation system 129 will automatically comply with framework specification 132.

Operations in FIG. 1B may be similar to those in FIG. 1A, with modeling automation system 129 receiving input from architects or designers of an application. For instance, in an example that can be described with reference to FIG. 1B, graphical modeling system 122 outputs a user interface enabling a user (e.g., architect or developer) to visually or graphically model aspects of an application under development. In some examples, the user interface enables a user to specify events associated with the application, and in such an example, the user interface may guide the user (e.g., by prompting the user for appropriate input) to specify various events associated with the application under development. The user interface may also enable a user to specify other attributes of the application under design. For example, the user interface may enable the user to specify, in the DDD context, domains, subdomains, bounded contexts and relationships, events, commands, queries, policies, data objects, application programming interfaces (APIs), request and response protocols, data consistency protocols, saga pattern design considerations, and event modeling data. Based on input received through the user interface(s), graphical modeling system 122 generates graphical model artifacts 123. Graphical model artifacts 123 may include information about the design of the application that facilitates generation of a model of the application by model generator 126. In general, graphical modeling system 122 structures the user interface(s) presented to users (e.g., designers) in a way that ensures that the input received can be translated into graphical model artifacts 123 that can then be converted to framework definition artifacts 127 that comply with framework specification 132. Graphical modeling system 122 interprets the input it receives the user interface and generates graphical model artifacts 123. Graphical model artifacts 123 may, in some examples, serve as intermediate or internal data that is used to eventually generate framework definition artifacts 127.

Modeling automation system 129 may generate framework definition artifacts 127. For instance, continuing with the example described with reference to FIG. 1B, graphical modeling system 122 outputs graphical model artifacts 123 to model generator 126. In the example being described, graphical model artifacts 123 are arranged or expressed to model generator 126 in a way that enables model generator 126 to interpret graphical model artifacts 123 in the context of framework specification 132. Model generator 126 uses graphical model artifacts 123 to generate framework definition artifacts 127, each of which complies with framework specification 132.

Code generator 130 may generate skeleton code 135 based on framework definition artifacts 127. For instance, similar to the example described in connection with FIG. 1A, model generator 126 of FIG. 1B outputs framework definition artifacts 127 to code generator 130. Code generator 130 maps framework definition artifacts 127 to code templates within code library 131 to create skeleton code 135. In examples where framework definition artifacts 127 are expressed in a manner that complies with framework specification 132, code generator 130 may be able to map framework definition artifacts 127 to code templates 139 within code library 131 and assemble skeleton code 135 without ambiguity and/or with little or no additional user input.

Repository 170 may deploy an executable version of production code 181 within deployment environment 180. For instance, as in the example described in connection with FIG. 1A, code generator 130 outputs skeleton code 135 to repository 170. Developers modify skeleton code 135 to produce production code 181. Repository 170 outputs an executable version of production code 181 to deployment environment 180 and configures deployment environment 180 to execute production code 181.

The techniques described herein may provide certain technical advantages. For instance, by providing a framework specification 132 that enables artifacts of an application design to be expressed in a manner that facilitates mapping of those artifacts to boilerplate code or code templates 139 within code library 131, a nearly-complete programming code skeleton of the application being designed can be produced in a standardized, and near-automated way. The programming code skeleton may include code templates 139 that are pre-configured to appropriately interoperate in a manner consistent with the design of the application, and the code skeleton might only require developers to implement logic or customizations that are specific to the particular application being designed. Such a process frees developers from implementing much of the code typically included within an application, particularly code that is similar to code performing the same functions in other applications. Such a process also enables developers to focus development time on writing code that is specific to the application being developed. Accordingly, techniques described herein may enable developers or organizations to jump-start the development of an application under design and reduce time to market.

Techniques described herein may also enable establishment of a guardrail to guide development of diverse applications across an organization. For instance, some organizations, particularly large organizations, may undertake development of a diverse set of applications, some of which may eventually need to interoperate with other applications or comply with various organizational processes and/or regulatory standards. If each development group within an organization uses a common process for generating programming code skeleton applications, code across the organization will have a similar form. As a result, the consistency and reliability of the development efforts across the organization will be enhanced. Further, developers across the organization will be more likely to readily understand and evaluate code written by other development teams within the organization, which may enhance cross-collaboration and interoperability between development teams. In addition, code developed by diverse development teams is more likely to comply with an organization-wide understanding of the business domain in which each developed application operates. This may result in enhanced interoperability between applications developed by different development teams within the organization.

In general, there are several challenges that techniques described herein can solve or at least favorably address for organizations seeking to design and develop applications in various domains. For example, techniques described herein may address problems relating to an inability to rapidly respond to business process changes, high operational costs, resource-intensive manual processes, long times to market for any design changes, data management with no end-to-end traceability, tightly-coupled systems with large infrastructure footprints, vendor proprietary technologies, problems stemming from organizations that lack a modern technology skillset, and others.

Techniques described herein can be applicable to many development contexts and in different development environments. However, such techniques may be particularly applicable to applications developed based on modern architecture, cloud-based systems and/or microservices-based systems. Further, object-oriented programming languages (e.g., such as Java, C#or .NET languages, Python) may be particularly appropriate for code templates 139 that are used to implement DDD-based designs. However, techniques described herein may be applied to other modern development languages and toolsets.

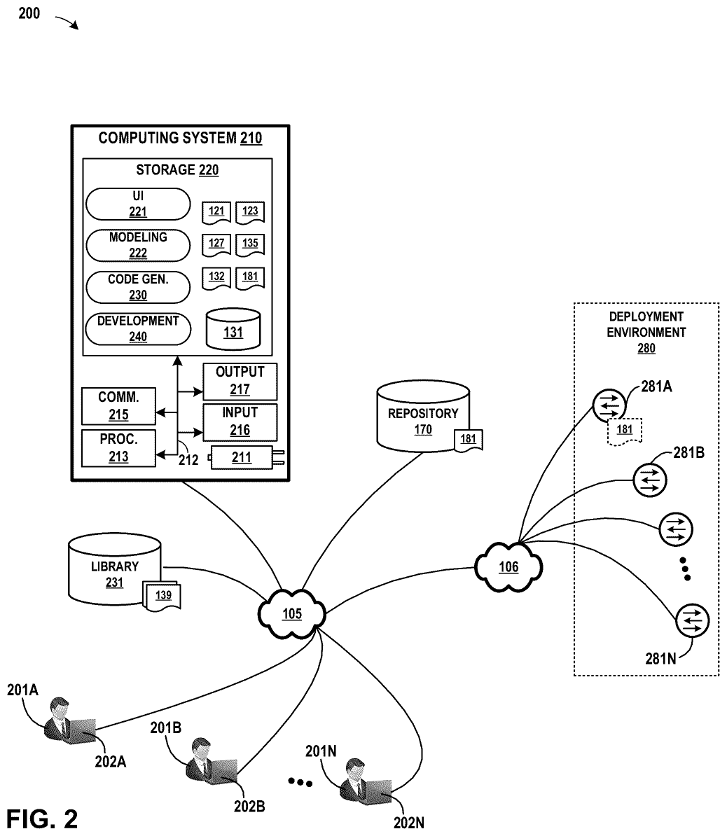

FIG. 2 is a block diagram illustrating an example system for interpreting design artifacts and transforming design artifacts into source code, in accordance with one or more aspects of the present disclosure. System 200 of FIG. 2 may be described as an example or alternative implementation of system 100A of FIG. 1A or system 100B of FIG. 1B. System 200 includes computing system 210, code library 231, and repository 170 connected through network 105. One or more architects, developers, domain-experts, or stakeholders 201A through 201N (hereinafter “users 201”) are illustrated operating user devices 202A through user devices 202N (“user devices 202”), each also in communication with other systems illustrated in FIG. 2 through network 105. User devices 202 may be any suitable computing system, including a mobile, non-mobile, wearable, and/or non-wearable computing device. Each of user devices 202 may be, for example, a desktop or laptop computing device, a workstation, a smart phone or tablet, or other computing device.

Repository 170 may correspond to repository 170 illustrated in FIG. 1A and FIG. 1B, and may be considered an example or alternative implementation of repository 170 of FIG. 1A or FIG. 1B. Similarly, code library 231 of FIG. 2 may correspond to code library 131 illustrated FIG. 1A and FIG. 1, and may represent a network-accessible system or repository that performs functions similar to, or that stores information similar to, code library 131 of FIG. 1A or FIG. 1. Accordingly, code library 231 may be considered an example or alternative implementation of code library 131 illustrated in FIG. 1A and FIG. 1. Code library 231 may store and provide access to various code templates 139 in a manner similar to that described in connection with FIG. 1A and FIG. 1B.

Computing system 210 is described herein as performing many of the operations performed by design modeling system 120 and code generator 130 of FIG. 1A, and modeling automation system 129 and code generator 130 of FIG. 1. Accordingly, computing system 210 may be considered an example or alternative implementation of those systems of FIG. 1A and FIG. 1B.

Although computing system 210 is illustrated as a single system in FIG. 2, computing system 210 of FIG. 2 can be considered to be implemented through multiple computing systems operated by multiple users. In other words, computing system 210, as illustrated in FIG. 2, can be considered to represent a system that may include one or more server computers, workstations, mainframes, appliances, cloud computing systems, and/or other computing devices that may be capable of performing operations and/or functions described in accordance with one or more aspects of the present disclosure. Computing system 210 thus may represent a cloud computing system, server farm, and/or server cluster (or portion thereof) that provides services to client devices and other devices or systems. Computing system 210 may also represent or be implemented through one or more virtualized compute instances (e.g., virtual machines, containers) of a data center, cloud computing system, server farm, and/or server cluster.

Network 105 is shown in communication with network 106, and one or more microservices 281 (i.e., microservices 281A through 281N) are shown deployed within deployment environment 280 accessible through network 106. One or more of these microservices 281 may execute on compute nodes or computing infrastructure within network 106 (the computing infrastructure on which such microservices execute is not specifically illustrated in FIG. 2). Although examples herein are often described in the context of a microservices architecture, techniques described herein may apply to other types of architectures whether now known or hereafter developed.

In some examples, network 105 may represent any public or private communications network or other network, and in some examples, may be or may be part of the internet. Similarly, network 106 may also represent any public or private communications network or data center, and may also be, or may be part of, the internet. Although network 105 and network 106 are illustrated in FIG. 2 as separate networks, in other examples, network 105 may be implemented as a single network. Alternatively, in some examples, networks 105 and 106 may each include multiple networks.

In FIG. 2, computing system 210 is illustrated as including underlying physical hardware that includes power source 211, one or more processors 213, one or more communication units 215, one or more input devices 216, one or more output devices 217, and one or more storage devices 220. Storage devices 220 may include user interface module 221, modeling module 222, code generation module 230, development module 240, and code library 131 (which may be an additional code library maintained by computing system 210).

Also stored within storage devices 220 may be additional information, such as one or more instances of design artifacts 121, graphical model artifacts 123, framework definition artifacts 127, skeleton code 135, production code 181, and/or code templates (not specifically shown). Framework specification 132, or at least information sufficient to check or ensure compliance with framework specification 132, may also be stored within storage device 220.

One or more of the devices, modules, storage areas, or other components of computing system 210 may be interconnected to enable inter-component communications (physically, communicatively, and/or operatively). In some examples, such connectivity may be provided by through communication channels, which may include a system bus (e.g., communication channel 212), a network connection, an inter-process communication data structure, or any other method for communicating data.

Power source 211 of computing system 210 may provide power to one or more components of computing system 210. One or more processors 213 of computing system 210 may implement functionality and/or execute instructions associated with computing system 210 or associated with one or more modules illustrated and/or described herein. One or more processors 213 may be, may be part of, and/or may include processing circuitry that performs operations in accordance with one or more aspects of the present disclosure. One or more communication units 215 of computing system 210 may communicate with devices external to computing system 210 by transmitting and/or receiving data, and may operate, in some respects, as both an input device and an output device. In some or all cases, communication unit 215 may communicate with other devices or computing systems over network 105 or over other networks.

One or more input devices 216 may represent any input devices of computing system 210 not otherwise separately described herein, and one or more output devices 217 may represent any output devices of computing system 210 not otherwise separately described herein. Input devices 216 and/or output devices 217 may generate, receive, and/or process output from any type of device capable of outputting information to a human or machine. For example, one or more input devices 216 may generate, receive, and/or process input in the form of electrical, physical, audio, image, and/or visual input (e.g., peripheral device, keyboard, microphone, camera). Correspondingly, one or more output devices 217 may generate, receive, and/or process output in the form of electrical and/or physical output (e.g., peripheral device, actuator).

One or more storage devices 220 within computing system 210 may store information for processing during operation of computing system 210. Storage devices 220 may store program instructions and/or data associated with one or more of the modules described in accordance with one or more aspects of this disclosure. One or more processors 213 and one or more storage devices 220 may provide an operating environment or platform for such modules, which may be implemented as software, but may in some examples include any combination of hardware, firmware, and software. One or more processors 213 may execute instructions and one or more storage devices 220 may store instructions and/or data of one or more modules. The combination of processors 213 and storage devices 220 may retrieve, store, and/or execute the instructions and/or data of one or more applications, modules, or software. Processors 213 and/or storage devices 220 may also be operably coupled to one or more other software and/or hardware components, including, but not limited to, one or more of the components of computing system 210 and/or one or more devices or systems illustrated or described as being connected to computing system 210.

User interface module 221 may manage user interactions with computing system 210, and cause computing system 210 to output various user interfaces for display or presentation or otherwise, as a user of computing system 210 views, hears, or otherwise senses output and/or provides input at computing system 210 or at a remote computing system (e.g., one of user devices 202) over network 105. In some examples, user interface module 221 may receive information and instructions from a platform, operating system, application, and/or service executing at computing system 210, at a client device, and/or one or more remote computing systems (e.g., user devices 202). In addition, user interface module 221 may act as an intermediary between a platform, operating system, application, and/or service executing at client device and various output devices of such a client (e.g., speakers, LED indicators, audio or electrostatic haptic output devices, light emitting technologies, displays, etc.) to produce output (e.g., a graphic, a flash of light, a sound, a haptic response, etc.).

Modeling module 222 may perform functions relating to processing input and generating, based on that input, design artifacts 121 or graphical model artifacts 123 that correspond to a domain-driven design process. In addition, modeling module 222 may map design artifacts 121 to framework definition artifacts 127. In some cases, such as where a graphical design tool is used, modeling module 222 may generate graphical model artifacts 123 and use such graphical model artifacts 123 to generate model. Based on the generated model, modeling module 222 may generate framework definition artifacts 127.

Code generation module 230 may perform functions relating to transforming framework definition artifacts 127 into skeleton code 135. To do so, code generation module 230 may map various framework definition artifacts 127 to code templates included within code library 131. Generally, code generation module 230 interconnects the code templates to create skeleton code 135. Alternatively, or in addition, code generation module 230 may cause computing system 210 to access code library 231 over network 105 and use various code templates 139 stored within code library 231 to generate skeleton code 135.

Development module 240 may perform functions relating to application development. Development module 240 may be responsible for accepting developer input (e.g., corresponding to modifications to skeleton code 135) and processing such input by, for example, checking and/or compiling code and generating executable versions of programs using such code. Development module 240 may be responsible for committing code to repository 170, pulling code from 170, and/or otherwise interacting with repository 170. Development module 240 may also be responsible for deploying code (e.g., production code 181) to systems within a data center or deployment environment (e.g., deployment environment 280).

Code library 131 of computing system 210 may represent any suitable data structure or storage medium for storing code templates, boilerplate code, and similar information. Code library 131 illustrated in FIG. 2 may correspond to code library 131 of FIG. 1A and FIG. 1B. The information stored in code library 131 may be searchable and/or categorized to align with one or more framework specifications 132. In some examples, one or more modules within computing system 210, such as code generation module 230, may provide an input requesting information from code library 131, and in response to the input, receive an appropriate code template stored within code library 131. Code library 131 may be primarily maintained by code generation module 230.

Other items illustrated as being stored within storage devices 220 of computing system 210 may correspond to like-numbered items illustrated in FIG. 1A and/or FIG. 1B. Such items include design artifacts 121, graphical model artifacts 123, framework definition artifacts 127, skeleton code 135, framework specification 132, and production code 181. Each of these items may correspond to a like-numbered item described in connection with FIG. 1A. Further, although FIG. 2 illustrates these items stored within storage device 220 of computing system 210, one or more of such items may be stored elsewhere and available over network 105. In particular, certain information about framework specification 132 (e.g., logic for ensuring compliance with framework specification 132) might be stored within storage device 220, but in some examples, framework specification 132 might be stored at another location within system 200.

In FIG. 2, and in accordance with one or more aspects of the present disclosure, computing system 210 may generate design artifacts 121. For instance, in an example that can be described in the context of FIG. 2, input device 216 of computing system 210 detects input and outputs an indication of input to user interface module 221. User interface module 221 determines that the input corresponds to design activity, such as might be undertaken by architects, developers, domain experts, and/or others. User interface module 221 outputs information about the input to modeling module 222. Modeling module 222 determines that the input is associated with an application under development. Modeling module 222 may determine that the input includes information about domains applicable or used by the application, information about events, commands, queries, request/response sequences that the application will use, information about event models that may be appropriate, and other information. Modeling module 222 interprets this information as part of a design process associated with an application under development. Modeling module 222 may use the information, along with other information received as input to computing system 210 (e.g., at earlier or later times) or received from other computing systems, to model the application under development. Modeling module 222 generates various design artifacts 121, which represent or correspond to the information about the development. In the DDD context, design artifacts 121 may include information about domains, subdomains, bounded contexts and relationships, events, commands, queries, policies, data objects, application programming interfaces (APIs), request and response protocols, data consistency protocols, saga pattern design considerations, and event modeling data.

Computing system 210 may generate graphical model artifacts 123. For instance, in an example in which user interface module 221 provides a graphical modeling tool (e.g., graphical modeling system 122 in FIG. 1B) that supports enabling design activity to be modeled graphically or visually, modeling module 222 may receive input from user interface module 221 and generate graphical model artifacts 123 in response to such input. In such an example, user interface module 221 may, at the direction of modeling module 222, output a series of user interfaces that guide the designer, developer, or user to provide input specifying or describing various aspects of the application under development. In response to receiving input through such user interfaces, user interface module 221 and modeling module 222 interpret the input to create graphical model artifacts 123.

Computing system 210 may generate framework definition artifacts 127. For instance, continuing with the example being described in the context of FIG. 2, modeling module 222 accesses graphical model artifacts 123 stored within storage device 220. Modeling module 222 uses graphical model artifacts 123 to generate framework definition artifacts 127. In some examples, graphical model artifacts 123 have been generated to comply with framework specification 132, thereby facilitating translation graphical model artifacts 123 to framework definition artifacts 127. In other examples, one or more architects or developers may manually prepare one or more files that correspond to framework definition artifacts 127. In doing so, such architects or developers may use a text editor to create files in an appropriate form to comply with framework specification 132. In some examples, framework definition artifacts 127 may take the form of YAML files (e.g., see FIG. 3A through FIG. 3G), but other formats are possible.

Computing system 210 may generate skeleton code 135. For instance, again referring to FIG. 2, input device 216 detects input and outputs information about the input to code generation module 230. Code generation module 230 determines that the input corresponds to a request to generate a code template based on various framework definition artifacts 127. Code generation module 230 identifies the appropriate framework definition artifacts 127 and maps information within framework definition artifacts 127 to specific code templates 139 accessible within code library 231. Code generation module 230 then causes communication unit 215 to output a signal over network 105. Code library 231 receives a signal and determines that the signal corresponds to a request for specific code templates 139 stored within code library 231. Code library 231 outputs a signal over network 105. Communication unit 215 of computing system 210 detects a signal and outputs information about the signal to code generation module 230. Code generation module 230 determines that the signal includes the requested code templates 139. Code generation module 230 assembles code templates 139 into skeleton code 135, interconnecting each of code templates 139 in a way that is consistent with or is specified by framework definition artifacts 127.

Computing system 210 may produce production code 181. For instance, continuing with the example being described in the context of FIG. 2, input device 216 detects input and outputs information about the input to development module 240. Development module 240 determines that the input corresponds to development activity providing modifications to and/or furnishing additional code for skeleton code 135. Development module 240 may receive information about further input that it determines corresponds to a request to commit various changes that have been skeleton code 135. In response to such a request, development module 240 causes communication unit 215 to output a signal over network 105. Repository 170 detects a signal over network 105 and determines that the signal includes information about a version of skeleton code 135 that one or more developers are seeking to commit to repository 170. Repository 170 stores information about the commit. Development module 240 of computing system 210 may receive additional input associated with development activity, and eventually, development module 240 receives a request to commit production code 181 to repository 170. As part of this process, computing system 210 may store various intermediate versions of skeleton code 135 within repository 170. In the example being described, production code 181 is an updated version of skeleton code 135 after developers have added additional code to skeleton code 135 to implement functionality or business logic specific to the application being designed. Development module 240 causes communication unit 215 to output a signal over network 105. Repository 170 detects a signal and determines that the signal includes a request to commit changes that result in production code 181. Repository 170 stores production code 181.

Computing system 210 may deploy production code 181 within deployment environment 280. For instance, still continuing with the example being described with reference to FIG. 2, input device 216 detects input and outputs information about the input to development module 240. Development module 240 determines that the input corresponds to a request to deploy production code 181 within deployment environment 280. Development module 240 causes communication unit 215 to output a signal over network 105. Repository 170 detects a signal and determines that the signal corresponds to a request to deploy production code 181 within deployment environment 280. Repository 170 outputs a signal over network 105 to network 106. Network 106 detects the signal and routes the signal to deployment environment 280. One or more systems within deployment environment 280 determine that the signal includes production code 181 and information about deploying production code 181 as one or more microservices 281. Deployment environment 280 starts executing production code 181 as one or more microservices 281.

Computing system 210 may receive information about an updated design. For instance, again referring to FIG. 2, computing system 210 detects input that modeling module 222 determines corresponds to changes to design artifacts 121, graphical model artifacts 123, and/or framework definition artifacts 127 being made by one or more architects, developers, or designers. In this example, after initial production code 181 has been generated and deployed, further design changes may take place, which result in the described input specifying such design changes.

Computing system 210 may propagate the changes to the design through to the source code deployed within deployment environment 280. For instance, again referencing FIG. 2, modeling module 222 generates or receives updated framework definition artifacts 127 corresponding to the new or updated design. Based on these updated framework definition artifacts 127, modeling module 222 determines what modifications need to be made to skeleton code 135 underlying production code 181. Modeling module 222 may receive further information about development or code changes (e.g., from developers) that are appropriate for implementing the specific business logic or specialized processing for the application to be performed by the application pursuant to the new model. Modeling module 222 may perform a three-way merge of this information, merging the updated framework definition artifacts 127, the code changes from developers, and the existing production code 181. Based on this three-way merge operation, modeling module 222 generates a new version of production code 181. In some examples, this three-way merge operation is performed by repository 170. In examples where the merge is performed by computing system 210, the resulting new version of production code 181 is pushed to repository 170 by computing system 210 over network 105.

Computing system 210 may deploy updated production code 181 within deployment environment 280. For instance, once again with reference to the example being described in the context of FIG. 2, input device 216 detects input that development module 240 determines corresponds to a request to deploy the new version of production code 181. Computing system 210 communicates with repository 170, and causes repository 170 to output the new version of production code 181 to deployment environment 280 and cause deployment environment 280 to execute the new version of production code 181 as one or more microservices 281.

Modules illustrated in FIG. 2 (e.g., user interface module 221, modeling module 222, code generation module 230, and development module 240) and/or illustrated or described elsewhere in this disclosure may perform operations described using software, hardware, firmware, or a mixture of hardware, software, and firmware residing in and/or executing at one or more computing devices. For example, a computing device may execute one or more of such modules with multiple processors or multiple devices. A computing device may execute one or more of such modules as a virtual machine executing on underlying hardware. One or more of such modules may execute as one or more services of an operating system or computing platform. One or more of such modules may execute as one or more executable programs at an application layer of a computing platform. In other examples, functionality provided by a module could be implemented by a dedicated hardware device.

Although certain modules, data stores, components, programs, executables, data items, functional units, and/or other items included within one or more storage devices may be illustrated separately, one or more of such items could be combined and operate as a single module, component, program, executable, data item, or functional unit. For example, one or more modules or data stores may be combined or partially combined so that they operate or provide functionality as a single module. Further, one or more modules may interact with and/or operate in conjunction with one another so that, for example, one module acts as a service or an extension of another module. Also, each module, data store, component, program, executable, data item, functional unit, or other item illustrated within a storage device may include multiple components, sub-components, modules, sub-modules, data stores, and/or other components or modules or data stores not illustrated.

Further, each module, data store, component, program, executable, data item, functional unit, or other item illustrated within a storage device may be implemented in various ways. For example, each module, data store, component, program, executable, data item, functional unit, or other item illustrated within a storage device may be implemented as a downloadable or pre-installed application or “app.” In other examples, each module, data store, component, program, executable, data item, functional unit, or other item illustrated within a storage device may be implemented as part of an operating system executed on a computing device.

FIG. 3A through FIG. 3G illustrate example definition files that may be used to describe or define one or more aspects of a domain-driven design, in accordance with one or more aspects of the present disclosure. Each of definition files 301A through 301G (“definition files 301”), illustrated in FIG. 3A through 3G, respectively, may correspond to one or more of framework definition artifacts 127 described in connection with FIG. 1A, FIG. 1B, and/or FIG. 2. In the examples illustrated, each of definition files 301 is shown expressed in a YAML (“YAML Ain′t Markup Language”) format, but other formats (e.g., XML or Javascript Object Notation) could be used. As described herein, each such definition file 301 is prepared with a format and content that is in compliance with one or more framework specifications 132. Also as described herein, if prepared pursuant to a specific framework specification 132, code generator 130 can map the definitions expressed within definition files 301 to code templates stored within code library 131 (or code library 231 of FIG. 2).

FIG. 3A illustrates an example of how one or more commands associated with an application design could be defined and expressed. Similarly, FIG. 3B illustrates an example of how one or more events associated with an application being designed could be defined and expressed. FIG. 3C illustrates a definition of queries associated with the application under development. FIG. 3D illustrates a definition of sagas associated with the application. FIG. 3E illustrates a definition of event handlers, FIG. 3F illustrates a definition of command handlers, and FIG. 3G illustrates a definition of query handlers.

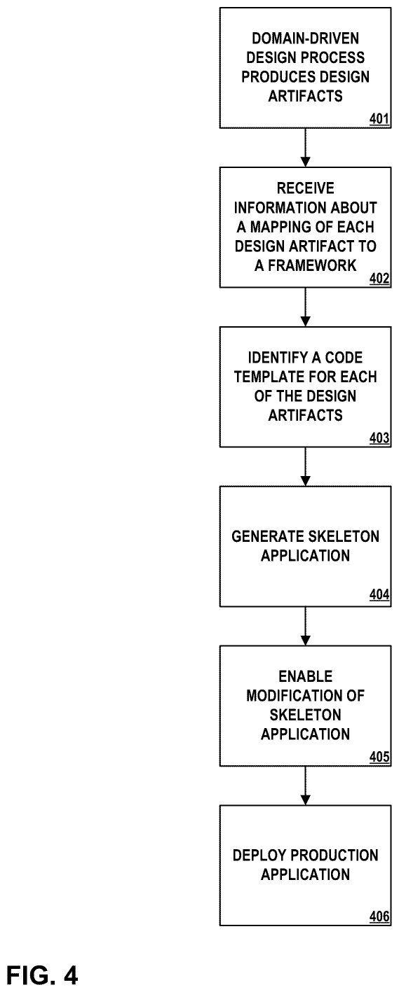

FIG. 4 is a flow diagram illustrating operations performed by an example system in accordance with one or more aspects of the present disclosure. FIG. 4 is described below within the context of system 100A of FIG. 1A. In other examples, operations described in FIG. 4 may be performed by one or more other components, modules, systems, or devices. Further, in other examples, operations described in connection with FIG. 4 may be merged, performed in a difference sequence, omitted, or may encompass additional operations not specifically illustrated or described.

In the process illustrated in FIG. 4, and in accordance with one or more aspects of the present disclosure, system 100A may enable a domain-driven design process that results in a plurality of design artifacts associated with a domain-driven design of the application (401). For example, design modeling system 120 of FIG. 1A may facilitate design activity taking place pursuant to a domain-driven design process for an application. In some examples, design modeling system 120 may provide text editing tools, modeling tools, drawing tools, access to framework specifications 132, information about code templates 139 stored within code library 131, and other tools and/or information.

System 100A may output a user interface configured to receive information about a mapping of each of the plurality of design artifacts to a framework of library code (402). For example, design modeling system 120 of FIG. 1A may output a graphical modeling tool to guide a user to describe an application model produced through a domain-driven design process. Design modeling system 120 may ensure that the information provided about the application complies with framework specification 132. Design modeling system 120 generates framework definition artifacts 127, which describe the application being designed in a way that complies with framework specification 132.

System 100A may identify, for each of the design artifacts, a code template from the framework of library code (403). For example, code generator 130 uses framework definition artifacts 127 to map each design artifact to one or more code templates 139 within code library 131. The mapping may be performed automatically if framework definition artifacts 127 appropriately complies with framework specification 132.

System 100A may generate, based in the identified code templates, a skeleton application (404). For example, code generator 130 assembles the mapped code templates 139 into an application, and interconnects each of code templates 139 in a way that is consistent with framework specification 132. Through such a process, code generator 130 generates skeleton code 135. Code generator 130 pushes skeleton code 135 to repository 170.

System 100A may enable modification of the skeleton application to produce a production application (405). For example, developers operating one or more computing systems that can be used for development (e.g., one or more of user devices 202 illustrated in FIG. 2) pull skeleton code 135 from repository 170. One or more developers engage in development activity (e.g., using user devices 202), adding code to skeleton code 135 to implement features of the application under design and/or to implement business logic for functions to be performed by the application. The developers cause computing systems to push the modifications to skeleton code 135 to repository 170. Eventually, sufficient modifications are made to skeleton code 135 to result in production code 181 being stored at repository 170.

System 100A may deploy the production application (406). For example, repository 170 outputs an executable version of production code 181 to deployment environment 180. Deployment environment 180 starts executing production code 181 as one or more microservices within deployment environment 180.

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Further certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

The disclosures of all publications, patents, and patent applications referred to herein are hereby incorporated by reference. To the extent that any such disclosure material that is incorporated by reference conflicts with the present disclosure, the present disclosure shall control.

For ease of illustration, only a limited number of devices, systems, or environments (e.g., design modeling system 120, code generator 130, code library 131, repository 170, deployment environment 180, computing system 210, code library 231, deployment environment 280, as well as others) are shown within the illustrations referenced herein. However, techniques in accordance with one or more aspects of the present disclosure may be performed with many more of such systems, components, devices, modules, and/or other items, and collective references to such systems, components, devices, modules, and/or other items may represent any number of such systems, components, devices, modules, and/or other items.

The illustrations included herein each illustrate at least one example implementation of an aspect of this disclosure. The scope of this disclosure is not, however, limited to such implementations. Accordingly, other example or alternative implementations of systems, methods or techniques described herein, beyond those illustrated herein, may be appropriate in other instances. Such implementations may include a subset of the devices and/or components included in the illustrations and/or may include additional devices and/or components not shown in the illustrations.

The detailed description set forth above is intended as a description of various configurations and is not intended to represent the only configurations in which the concepts described herein may be practiced. The detailed description includes specific details for the purpose of providing a sufficient understanding of the various concepts. However, these concepts may be practiced without these specific details. In some instances, well-known structures and components are shown in block diagram form in the referenced illustrations in order to avoid obscuring such concepts.

Accordingly, although one or more implementations of various systems, devices, and/or components may be described with reference to specific illustrations, such systems, devices, and/or components may be implemented in a number of different ways. For instance, one or more devices illustrated herein as separate devices may alternatively be implemented as a single device; one or more components illustrated as separate components may alternatively be implemented as a single component. Also, in some examples, one or more devices illustrated herein as a single device may alternatively be implemented as multiple devices; one or more components illustrated as a single component may alternatively be implemented as multiple components. Each of such multiple devices and/or components may be directly coupled via wired or wireless communication and/or remotely coupled via one or more networks. Also, one or more devices or components that may be illustrated herein may alternatively be implemented as part of another device or component that might not be shown in any illustration. In this and other ways, some of the functions described herein may be performed via distributed processing by two or more devices or components.

Further, certain operations, techniques, features, and/or functions may be described herein as being performed by specific components, devices, and/or modules. In other examples, such operations, techniques, features, and/or functions may be performed by different components, devices, or modules. Accordingly, some operations, techniques, features, and/or functions that may be described herein as being attributed to one or more components, devices, or modules may, in other examples, be attributed to other components, devices, and/or modules, even if not specifically described herein in such a manner.

Although specific advantages have been identified in connection with descriptions of some examples, various other examples may include some, none, or all of the enumerated advantages. Other advantages, technical or otherwise, may become apparent to one of ordinary skill in the art from the present disclosure. Further, although specific examples have been disclosed herein, aspects of this disclosure may be implemented using any number of techniques, whether currently known or not, and accordingly, the present disclosure is not limited to the examples specifically described and/or illustrated in this disclosure.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media, or communication media including any medium that facilitates transfer of a computer program from one place to another (e.g., pursuant to a communication protocol). In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, or optical disk storage, magnetic disk storage, or other magnetic storage devices, flash memory, or any other medium that can be used to store desired program code in the form of instructions or data structures and that can be accessed by a computer. Also, any connection may properly be termed a computer-readable medium. For example, if instructions are transmitted from a website, server, or other remote source using a wired (e.g., coaxial cable, fiber optic cable, twisted pair) or wireless (e.g., infrared, radio, and microwave) connection, then the wired or wireless connection is included in the definition of medium. It should be understood, however, that computer-readable storage media and data storage media do not include connections, carrier waves, signals, or other transient media, but are instead directed to non-transient, tangible storage media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the terms “processor” or “processing circuitry” as used herein may each refer to any of the foregoing structure or any other structure suitable for implementation of the techniques described. In addition, in some examples, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, a mobile or non-mobile computing device, a wearable or non-wearable computing device, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperating hardware units, including one or more processors as described above, in conjunction with suitable software and/or firmware.

1. A method comprising:
enabling a domain-driven design process for designing an application having an operational objective, wherein the domain-driven design process produces a plurality of design artifacts associated with a domain-driven design of the application;
outputting, by a computing system, a user interface configured to receive information about a mapping of the plurality of design artifacts to a framework of library code;
identifying, by the computing system and based on the received information about the mapping of the plurality of design artifacts, a plurality of code templates from the framework of library code;
generating, by the computing system and based on the identified plurality of code templates, a skeleton application, wherein generating the skeleton application includes configuring the plurality of code templates to work together in a way that accomplishes the operational objective;
enabling, by the computing system, modification of the skeleton application to produce a production application; and
deploying, by the computing system, the production application.

2. The method of claim 1, further comprising:
enabling, by the computing system, a design modification process for the application, wherein the design modification process produces a plurality of modified design artifacts;
receiving, by the computing system, information about a mapping for the plurality of modified design artifacts to the framework of library code; and
updating, based on the mapping of the modified design artifacts, the skeleton application.

3. The method of claim 2, further comprising:
enabling, by the computing system, modification of the production application based on the modified design artifacts.

4. The method of claim 3, wherein updating the production application includes:
performing a merge operation, wherein the merge operation includes merging information about the modified design artifacts, information about the modification of the production application, and information about the production application.

5. The method of claim 1, wherein the framework of library code includes:
a framework specification that specifies how application design artifacts are to be described during the domain-driven design process.

6. The method of claim 5, wherein outputting the user interface includes:
outputting a user interface configured to receive information that complies with the framework specification.

7. The method of claim 1, wherein outputting the user interface includes:
outputting a user interface that guides a user to define the design artifacts to automatically comply with the framework specification.

8. The method of claim 7, wherein outputting the user interface further includes:
outputting a user interface enabling the design artifacts to be specified through visual interactions with the user interface.

9. The method of claim 1,
wherein the design includes a model of the application that is based on a domain associated with the application.

10. The method of claim 1, wherein deploying the production application includes:
deploying the production application in a microservices cloud-based environment.

11. A computing system comprising processing circuitry and a storage device, wherein the processing circuitry has access to the storage device and is configured to:
enable a domain-driven design process for designing an application having an operational objective, wherein the domain-driven design process produces a plurality of design artifacts associated with a domain-driven design of the application;
output a user interface configured to receive information about a mapping of the plurality of design artifacts to a framework of library code;
identify, based on the received information about the mapping of the plurality of design artifacts, a plurality of code templates from the framework of library code;
generate, based on the identified plurality of code templates, a skeleton application, wherein to generate the skeleton application, the processing circuitry configures the plurality of code templates to work together in a way that accomplishes the operational objective;
enable modification of the skeleton application to produce a production application; and
deploy the production application.

12. The computing system of claim 11, wherein the processing circuitry is further configured to:
enable a design modification process for the application, wherein the design modification process produces a plurality of modified design artifacts;
receive information about a mapping for each of the plurality of modified design artifacts to the framework of library code; and
update, based on the mapping of each of the modified design artifacts, the production application.

13. The computing system of claim 12, wherein the processing circuitry is further configured to:
enable modification of the production application based on the modified design artifacts.

14. The computing system of claim 13, wherein to update the production application, the processing circuitry is further configured to:
perform a merge operation, wherein the merge operation includes merging information about the modified design artifacts, information about the modification of the production application, and information about the production application.

15. The computing system of claim 11, wherein the framework of library code includes:
a framework specification that specifies how application design artifacts are to be described during the domain-driven design process.

16. The computing system of claim 15, wherein to output the user interface, the processing circuitry is further configured to:
output a user interface configured to receive information that complies with the framework specification.

17. The computing system of claim 11, wherein to output the user interface, the processing circuitry is further configured to:
output a user interface that guides a user to define the design artifacts to automatically comply with the framework specification.

18. The computing system of claim 17, wherein to output the user interface, the processing circuitry is further configured to:
output a user interface enabling the design artifacts to be specified through visual interactions with the user interface.

19. The computing system of claim 11,
wherein the design includes a model of the application that is based on a domain associated with the application.

20. Non-transitory computer-readable media comprising instructions that, when executed, cause processing circuitry of a computing system to:
enable a domain-driven design process for designing an application having an operational objective, wherein the domain-driven design process produces a plurality of design artifacts associated with a domain-driven design of the application;
output a user interface configured to receive information about a mapping of the plurality of design artifacts to a framework of library code;
identify, based on the received information about the mapping of the plurality of design artifacts, a plurality of code templates from the framework of library code;
generate, based on the identified plurality of code templates, a skeleton application, wherein to generate the skeleton application, the processing circuitry configures the plurality of code templates to work together in a way that accomplishes the operational objective;
enable modification of the skeleton application to produce a production application; and
deploy the production application.
